(19) United States
(12) Patent Application Publication
(10) Pub. No.: US 2005/0271792 A1
(43) Pub. Date: Dec. 8, 2005

(54) Method of making braided meat product and food product made in accordance with the method

(75) Inventor: Eugene D. Gagliardi JR., Atglen, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Packerland Packing Company, Inc.

(21) Appl. No.: 11/145,787

(22) Filed: Jun. 6, 2005

Related U.S. Application Data
(60) Provisional application No. 60/577,989, filed on Jun. 7, 2004.

(51) Int. Cl. A23L 1/31

(52) U.S. Cl. 426/641

(57) ABSTRACT

A method of making a braided meat product from a generally elongated, boneless cut of meat includes the steps of: cutting the elongated boneless meat cut lengthwise into at least two and preferably three generally equal sized elongated boneless meat strips; and braiding the meat strips with each other to establish an elongated braided meat product. In one embodiment the boneless meat cut is first trimmed to remove any fat, membranes or the like prior to cutting the strips. At least one of the ends of the braided meat product is secured, for example with a cord, to prevent the meat product from becoming unbraided.

### CROSS REFERENCE TO RELATED APPLICATIONS

This non-provisional patent application claims the benefit of U.S. Provisional Patent Application No. 60/577,989 filed Jun. 7, 2004 and entitled Method of Making Braided Meat Product, the subject matter of which is hereby incorporated herein by reference.

### BACKGROUND OF THE INVENTION

The present invention relates generally to meat products and, more particularly, to a method of making a braided meat product and the meat product made in accordance with the method.

Recently, many methods and techniques have been newly developed for the purpose of enhancing the flavor, appearance or ease of preparation/cooking of certain meats. In addition, many such newly developed methods and techniques have been employed for enhancing value by creating a more valuable, higher demand meat product from what was previously a less valuable meat product. The present invention comprises a method of making a boneless low fat meat product which is quick and easy to cook. A braided meat product in accordance with the present invention is quite lean and easy to carve and, once cooked, provides an enhanced plate presentation. In addition, a meat product made in accordance with the present invention has the ability to receive and retain glazes or other toppings, making the cooked meat product tastier and juicier.

### BRIEF SUMMARY OF THE INVENTION

Briefly stated, the present invention, in one embodiment comprises a method of making a braided meat product from a generally elongated, boneless cut of meat. The method comprises the steps of: cutting the elongated boneless meat cut lengthwise into at least two generally equal sized elongated boneless meat strips; and braiding the meat strips with each other to establish an elongated braided meat product

In another embodiment the present invention comprises a method of making a braided meat product from a generally elongated, boneless pork loin. The method comprises the steps of: trimming the pork loin to remove the chain, fat cap and any other such components to provide a denuded pork loin eye; cutting the denuded pork loin eye lengthwise into at least two generally equal sized elongated boneless strips; and braiding the denuded pork loin eye strips with each other to establish an elongated braided meat product.

In yet another embodiment the present invention comprises a method of making a braided meat product from a generally elongated, boneless pork loin. The method comprises the steps of: trimming the pork loin to remove the chain, fat cap and any other such components to provide a denuded pork loin eye; cutting the denuded pork loin eye lengthwise from a first end toward but not completely to the second end into three generally equal sized elongated boneless strips which remain attached at the second end; braiding the denuded pork loin eye strips with each other to establish an elongated braided meat product; and tying the first end of the braided meat product with a cord to prevent the braided meat product from becoming unbraided.

### BRIEF DESCRIPTION OF THE SEVERAL VIEWS OF THE DRAWINGS

The foregoing summary as well as the following detailed description of the invention will be better understood when read in conjunction with the appended drawings. For the purpose of illustrating the invention, there is shown in the drawing an embodiment which is presently preferred. It should be understood, however, that the invention is not limited to the precise arrangements and instrumentalities shown.

In the drawings:

FIG. 1 is a top perspective view of a boneless pork loin including the loin chain which is used to illustrate the preferred method of the present invention;

FIG. 2 is a bottom perspective view of the pork loin of FIG. 1 illustrating the loin fat cap;

FIG. 3 is a top perspective view of the pork loin of FIG. 1 showing the chain and fat cap being removed from the remaining pork loin eye;

FIG. 4 is a top perspective view of the pork loin of FIG. 1 showing the denuded pork loin eye which has been completely separated from the chain and fat cap;

FIG. 5 is a top perspective view of the denuded pork loin eye of FIG. 4 cut longitudinally into three elongated pieces joined together at a second end;

FIG. 6 is a top perspective view of the denuded pork loin eye of FIG. 5 showing the beginning of the braiding of the three elongated pieces;

FIG. 7 is a top perspective view of the denuded pork loin eye of FIG. 4 upon completion of the braiding process; and

FIG. 8 is a top perspective view similar to that of FIG. 7 but with the first end of the braided, denuded pork loin eye tied.

### DETAILED DESCRIPTION OF THE INVENTION

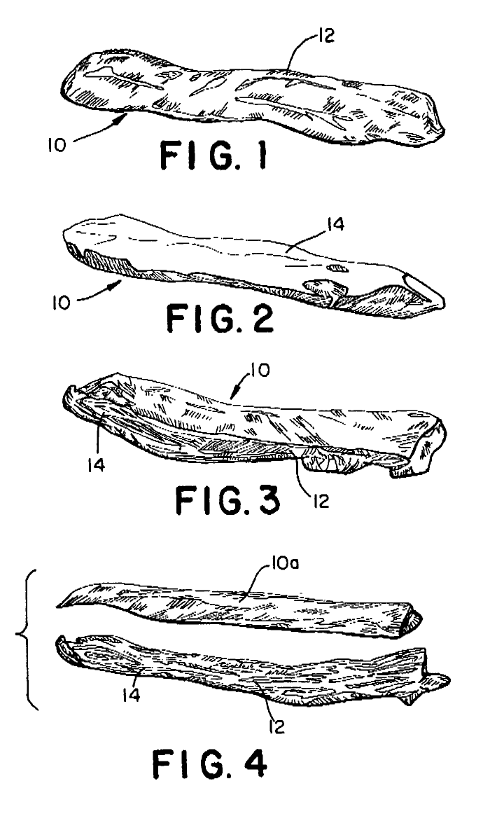

Referring to the drawings in detail wherein like numerals indicate like elements throughout the several figures, there is shown in FIGS. 1 and 2 top and bottom perspective views of a boneless pork loin 10 which will be used for purposes of illustrating the method of the present invention. It should be clearly understood by those of ordinary skill in the art that the present invention is not limited to being used with a boneless pork loin 10. Instead, the method of the present invention may be used with other cuts of pork or with similar cuts from other animals, such as beef, poultry, fowl, or the like. Accordingly, the present invention should not be construed to be limited to use with a boneless pork loin 10.

As shown in FIGS. 1 and 2, the boneless pork loin 10 includes the chain 12 and the fat cap 14 which are generally found on all such boneless pork loins. The chain 12 is the portion of the pork loin 10 that runs substantially the entire length of the boneless loin 10 which normally lies under or around the chine bone from which the boneless pork loin 10 has been removed. The chain 12 typically contains membrane, silver, cartilage and/or other inedible or undesirable components. The first step in practicing the preferred method in accordance with the present invention is to trim the pork loin 10 to remove the chain 12, the fat cap 14 and any other such components from the remainder of the boneless pork loin 10 to provide a “denuded” pork loin eye 10a which is comprised of essentially solid pork meat. The removal of the chain 12 and fat cap 14 is illustrated in FIGS. 3 and 4. The chain 12 and fat cap 14 may be removed utilizing a standard knife, saw, water knife or any other cutting apparatus known to those of ordinary skill in the art. In some applications, the chain 12 and fat cap 14 will have already been removed from the boneless pork loin 10 prior to the beginning of the present method. In such cases, the above-described first step of the present method may be omitted. The chain 12 and/or fat cap 14 may be used as grind or may be made into some other pork product, such as a restructured pork product of a type known to those of ordinary skill in the art. For example, the chain 12 and fat cap 14 may be run through a one millimeter plate of the type described in U.S. Pat. No. 5,765,768 one or two times, seasoned with a suitable sauce, such as barbecue sauce, formed into a log, cooled or frozen and then sliced into four ounce portions which may be cooked on a grill, fried or cooked in an oven to provide a sandwich pork portion. Other methods and techniques may be employed for making use of the chain 12 and fat cap 14.

Once the chain 12 and fat cap 14 have been removed, the remaining denuded pork loin eye 10a is placed with what had been the chain bone side down and is cut lengthwise into two or more and preferably three generally equal sized elongated portions or strips 10b, 10c and 10d as best shown in FIG. 5. Preferably, the cuts made along the denuded pork loin eye 10a begin at a first end but do not extend completely to the second end 10e. Instead, the second end 10e of the denuded pork loin eye 10a remains intact to effectively hold together the three elongated pork loin strips 10b, 10c and 10d. Alternatively, the cuts could be made completely through the denuded pork loin eye 10a so that each of the strips 10b, 10c and 10d are completely severed from the others at both ends. The denuded loin eye strips 10b, 10c and 10d may be cut utilizing a knife, saw, water knife or any other such cutting implement or apparatus known to those of ordinary skill in the art.

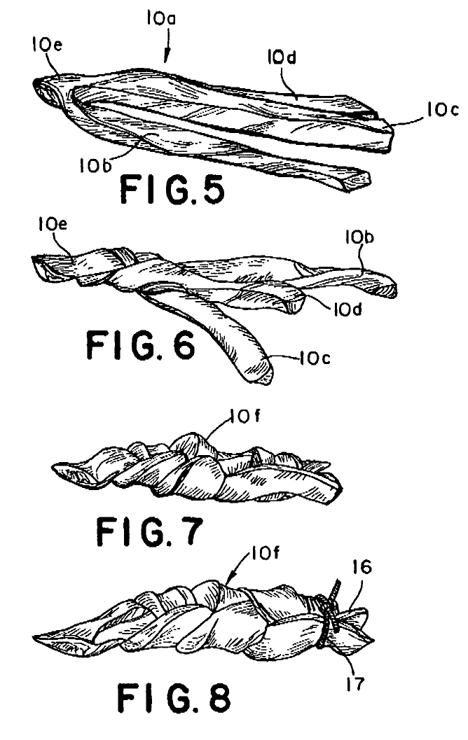

FIG. 6 illustrates the next step of the present method in which the three elongated denuded pork loin strips 10b, 10c and 10d are braided with each other. The braiding of the denuded pork loin strips 10b, 10c and 10d may be accomplished by hand or utilizing any suitable braiding or other equipment known to those skilled in the art. FIG. 6 illustrates the denuded pork loin strips 10b, 10c and 10d partially braided whereas FIG. 7 illustrates a completed meat product 10f which results from completion of the braiding of the denuded pork loin strips 10b, 10c and 10d. Preferably, the distal end of the braided pork loin product 10f opposite from the second or uncut end 10e is tied utilizing a short length of butcher's twine 17 or other suitable cord or the like or is otherwise secured to prevent the denuded pork loin strips 10b, 10c and 10d from becoming unbraided or unraveled during further processing, shipment or cooking.

The denuded braided pork loin product 10f is slightly shorter than the original boneless pork loin 10 shown in FIG. 1 and, because the chain 12 and fat cap 14 have been removed, it is leaner than the original boneless pork loin 10. Because the chain 12 and fat cap 14 have been removed, the braided, denuded pork loin product 10f is easier to carve and cooks in less time than would normally take the boneless pork loin 10 of FIG. 1. The braided denuded pork loin product 10f provides enhanced plate presentation, and any glaze, sauce or other topping added prior to, during or after cooking has the ability to seep into and remain captured within the area between the braids, making the braided denuded pork loin product 10f tastier and juicier than the boneless pork loin 10 of FIG. 1. The braided denuded pork loin product 10f can be pan fried, roasted or cooked on a grill. Preferably, prior to or during cooking, the braided denuded pork loin product 10f is brushed lightly with a glaze, marinade, sauce or other sauce or flavored topping.

From the foregoing it can be seen that the present invention comprises a method of making a braided meat product from a boneless pork loin or other suitable base meat cut as well as the braided meat product made in accordance with the method. It will be appreciated by those of ordinary skill in the art that changes could be made to the embodiment described above without departing from the broad inventive concepts thereof. It is understood, therefore, that this invention is not limited to the particular embodiment disclosed, but it is intended to cover modifications within the spirit and scope of the invention as defined by the appended claims.

1. A method of making a braided meat product from a generally elongated, boneless cut of meat, the method comprising the steps of:
cutting the elongated boneless meat cut lengthwise into at least two generally equal sized elongated boneless meat strips; and
braiding the meat strips with each other to establish an elongated braided meat product.

2. The method as recited in claim 1 further including the step of trimming the boneless cut of meat to remove any fat, gristle, membranes, silver or other such components prior to cutting the meat cut into the elongated strips.

3. The method as recited in claim 1 further including securing at least one of the ends of the elongated braided meat product to prevent the braided meat product from becoming unbraided.

4. The method as recited in claim 3 wherein the securing step comprises tying the at least one end of the braided meat product with a cord.

5. The method as recited in claim 1 wherein the cutting step involves cutting the boneless meat cut from a first end toward but not entirely to the second end so that the strips remain connected together at the second end.

6. The method as recited in claim 1 wherein the number of elongated boneless meat strips is three.

7. A braided meat product made in accordance with the method of claim 1.

8. A method of making a braided meat product from a generally elongated, boneless pork loin, the method comprising the steps of:
trimming the pork loin to remove the chain, fat cap and any other such components to provide a denuded pork loin eye;
cutting the denuded pork loin eye lengthwise into at least two generally equal sized elongated boneless strips; and
braiding the denuded pork loin eye strips with each other to establish an elongated braided meat product.

9. The method as recited in claim 8 wherein the cutting step involves cutting the denuded pork loin eye from a first end toward but not entirely to the second end so that the strips remain connected together at the second end.

10. The method as recited in claim 8 further including securing at least one of the ends of the braided meat product to prevent the braided meat product from becoming unbraided.

11. The method as recited in claim 8 wherein the number of elongated boneless strips is three.

12. A braided meat product made in accordance with the method of claim 8.

13. A method of making a braided meat product from a generally elongated, boneless pork loin, the method comprising the steps of:
trimming the pork loin to remove the chain, fat cap and any other such components to provide a denuded pork loin eye;
cutting the denuded pork loin eye lengthwise from a first end toward but not completely to the second end into three generally equal sized elongated boneless strips which remain attached at the second end;
braiding the denuded pork loin eye strips with each other to establish an elongated braided meat product; and
tying the first end of the braided meat product with a cord to prevent the braided meat product from becoming unbraided.

14. A braided meat product made in accordance with the method of claim 13.
